(19) United States
(12) Patent Application Publication
(10) Pub. No.: US 2025/0358159 A1
(43) Pub. Date: Nov. 20, 2025

(54) PACKET DURATION ESTIMATION

(71) Applicant: Nordic Semiconductor ASA, Trondheim (NO)

(72) Inventors: Fabian ANGARITA, Trondheim (NO); Sriram KANKIPATI, Whitefields Hyderabad Telangana (IN)

(73) Assignee: Nordic Semiconductor ASA, Trondheim (NO)

(21) Appl. No.: 19/120,354

(22) PCT Filed: Oct. 20, 2023
(86) PCT No.: PCT/EP2023/079302

§ 371 Date: Apr. 11, 2025

(30) Foreign Application Priority Data
Oct. 20, 2022 (IN) 202211060079
Dec. 8, 2022 (GB) 2218442.8

(51) Int. Cl. H04L 27/26; H04L 5/00

(52) U.S. Cl. CPC H04L 27/2602; H04L 5/0007

(57) ABSTRACT

A radio receiver device is provided. The radio receiver device is configured to receive a radio signal comprising a data packet with a packet duration, said data packet comprising a first portion and a second portion; to determine an initial estimate of the packet duration using data included in the first portion; to determine a correction factor for said initial estimate of the packet duration using data included in the second portion; and to combine the initial estimate and the correction factor to determine a refined estimate of the packet duration.

### BACKGROUND OF THE INVENTION

The present invention relates to devices and methods for estimating the duration of radio packets.

Packet-based radio communications, in which data is transmitted between devices in distinct blocks (“packets”), are commonplace. For instance, the IEEE 802.11 wireless LAN (“Wi-Fi”) standards define various packet-based protocols for wireless network communication.

Each packet typically contains one or more preamble portions followed by a payload, where the payload contains the actual data to be transmitted and the preamble includes information that facilitates ongoing communication. For instance, the preamble portions may include information identifying the structure of the packet and/or information for synchronising the receiver with the time and frequency of the incoming packet.

Many radio communication protocols require a receiver to send an acknowledgement or other response to a received packet. In some IEEE 802.11 communications, a receiver may be expected to send a reply to a given packet at a specific time after the packet has ended. The interval between the end of the data packet and the start of the response is referred to as the Short Interframe Space (SIFS). However, it can be difficult to identify directly an end point of a given packet with sufficient accuracy to time the response and, in any case, having to wait until the packet has ended to determine the response timing may limit processing time for the content of the response to the SIFS itself (which can be very short).

Therefore, some packet-based protocols (e.g. IEEE 802.11 standards) include information in the preamble that allows a receiver to determine the duration of the packet. Not only can this improve the accuracy with which the end point of the packet is identified, but it can also allow the receiver to work out the necessary response time well in advance, possibly before it has even received much of the payload.

Conventional methods for identifying a packet duration using the preamble include multiplying a value indicating a number of bytes in the packet (e.g. determined from the LENGTH field of an IEEE 802.11 preamble) by a value indicating a data rate of the packet (e.g. determined from the RATE field of an IEEE 802.11 preamble).

However, this approach may not be sufficiently accurate for some implementations. For instance, the using the LENGTH and RATE fields in the L-SIG portion of an IEEE 802.11ax packet as explained above may provide an accuracy of down to ±4 μs, but the IEEE 802.11ax standard includes a trigger-based multi-user protocol (HE TB) in which a response packet must be sent with an accuracy of ±0.4 μs. More accurate methods of determining a packet duration from preamble information suitable for meeting such requirements exist, but these can be complex to implement.

An improved approach may be desired.

### SUMMARY OF THE INVENTION

According to a first aspect of the present invention there is provided a radio receiver device configured:
to receive a radio signal comprising a data packet with a packet duration, said data packet comprising a first portion and a second portion;
to determine an initial estimate of the packet duration using data included in the first portion;
to determine a correction factor for said initial estimate of the packet duration using data included in the second portion; and
to combine the initial estimate and the correction factor to determine a refined estimate of the packet duration.

Thus, it will be appreciated by those skilled in the art that determining a refined estimate of the packet duration by determining an initial estimate and then refining this with a correction factor may deliver an accurate estimate for the packet duration with lower processing requirements than determining an equally accurate estimate with a conventional direct calculation using data from several portions in the packet.

Combining an initial estimate with a correction factor may require fewer and/or simpler calculation steps than alternative approaches, and some of these steps may be optimised to further reduce processing requirements. Reducing processing requirements whilst maintaining accuracy may advantageously allow the cost, size and/or power consumption of the radio receiver device to be reduced.

Efficiently determining an accurate estimate for the packet duration may facilitate accurate communication timing. For instance, in a set of embodiments, the radio receiver device is arranged to use the refined estimate for the packet duration to determine an end time of the data packet. For instance, the radio receiver device may be arranged to detect a start time of the data packet (e.g. by detecting one or more preamble portions of the packet containing a predetermined pattern), and to calculate an end time of the packet by adding the refined estimate of the packet duration to the start time.

Knowing accurately the end time of the data packet may, for instance, enable the radio receiver device to send an accurately timed response to the data packet. In a set of embodiments, the radio receiver device is arranged to use the refined estimate of the packet duration to determine a response time for responding to the data packet. For example, the response time may be a fixed interval (e.g. short interframe space (SIFS)) after an end time of the data packet. The radio receiver device may be a radio transceiver device. The radio transceiver device may be arranged to transmit a radio signal comprising a response to the data packet at a determined response time.

The data packet may be spread over a plurality of frequency bands. In some embodiments, at least part (and optionally all) of the data packet is modulated according to an orthogonal frequency-division multiplexing (OFDM) scheme (e.g. an orthogonal frequency-division multiple access (OFDMA) scheme), in which the data packet is spread over multiple orthogonal sub-carrier frequencies (sub-carriers). The first portion and the second portion may extend over all of the sub-carriers or a subset of the sub-carriers.

The first and/or second portions may comprise encoded bit sequences. For instance, the first and/or second portions may comprise OFDM symbols, in which their respective bit sequences are spread over multiple frequency subcarriers and/or multiple time slots (e.g. with each bit of an OFDM symbol carried simultaneously in a different sub-carrier). The first and second portions may use a phase-shift keying modulation scheme such as binary-phase-shift-keying (BPSK) or Quadrature BPSK (QBPSK). The radio receiver device may be arranged to decode and/or demodulate the first and/or second portions as necessary.

In some sets of embodiments, the data packet adheres to an IEEE 802.11 protocol. For instance, the data packet may be an IEEE 802.11ax data packet (e.g. an IEEE 802.11ax High Efficiency Multiple-User (HE-MU) format packet, or an IEEE 802.11ax High Efficiency Single-User (HE-SU) format packet).

The data packet may comprise a preamble followed by a payload (e.g. where the payload contains the actual data to be transmitted and the preamble includes information that facilitates ongoing communication as explained above). The first and second portions may form part of the preamble.

In a set of embodiments, determining the initial estimate of the packet duration comprises determining one or more values indicated by the first portion. The radio receiver device may be arranged to determine one or more values from the first portion and to perform one or more mathematical operations to said value(s) to determine the initial estimate. For example, the first portion may include information identifying a quantity of data contained in the data packet (e.g. a length of the data packet in bytes). The first portion may include information identifying a data rate of the data packet (e.g. a number of bytes per unit time). Determining the initial estimate of the packet duration may comprise combining said information (e.g. multiplying a quantity of data by a data rate).

In a set of embodiments, the first portion comprises a legacy signal (L-SIG) portion of an IEEE 802.11 data packet (e.g. an IEEE 802.11ax frame). The initial estimate of the packet duration may be calculated by combining data quantity information from a LENGTH field of the L-SIG portion with data rate information from a RATE field of the L-SIG portion.

The initial estimate may provide a reasonably accurate estimate of the packet duration, which is then refined with the correction factor. In a set of embodiments the initial estimate for the packet duration is accurate to within 20 μs or less, within 10 μs or less or within 4 μs or less.

The correction factor may improve the accuracy of the refined estimate of the packet duration compared to the initial estimate. In a set of embodiments, the refined estimate for the packet duration is accurate to within 2 μs or less, within 1 μs or less, within 0.5 μs or less or within 0.4 μs or less. In some embodiments the refined estimate may be considered to be an exact assessment of the packet duration.

Obtaining this improved accuracy with the correction factor may require additional processing and/or other resources, i.e. to process additional information from the second portion to determine the correction factor. It may be desirable to optimise the determination of the correction factor.

In a set of embodiments, determining the correction factor comprises determining one or more values indicated by the second portion. The radio receiver device may be arranged to determine one or more values from the second portion and to perform one or more mathematical operations to said value(s) to determine the correction factor.

In a set of embodiments, the second portion includes information identifying one or more of: a symbol duration in the data packet (e.g. a T_{SYM} parameter of an IEEE 802.11ax frame), a number of symbols in one or more fields of the data packet (e.g. an N_{HE_LTF} parameter of an IEEE 802.11ax frame), a duration of one or more fields in the data packet (e.g. a T_{HE_LTF_SYM} parameter of an IEEE 802.11ax frame), a midamble periodicity of the data packet (e.g. an M_{MA} parameter of an IEEE 802.11ax frame), and packet extension information (e.g. a PE Disambiguity parameter of an IEEE 802.11ax frame). Determining the correction factor may comprise combining said information (e.g. using mathematical operations). In a set of embodiments, the second portion comprises a High-Efficiency Signal (HE-SIG) portion of an IEEE 802.11ax data packet (e.g. an HE Multiple User (MU) frame).

In a set of embodiments, determining the correction factor also utilises data included in the first portion, e.g. a data quantity information from a LENGTH field of a L-SIG portion of an IEEE 802.11 frame and/or data rate information from a RATE field of a L-SIG portion of an IEEE 802.11 frame.

The inventors have recognised that determining the correction factor from information in the second portion of the data packet may comprise one or more steps with a limited number of possible inputs and outcomes. As such, in a set of embodiments, determining the correction factor comprises using one or more look-up tables which associate a plurality of input conditions with a corresponding plurality of outcomes. The radio receiver device may comprise a memory storing one or more look-up tables for use in determining the correction factor (although alternatively one or more look-up tables may be stored separately). Using a look-up for one or more calculation steps when determining the correction factor may reduce the processing power required to obtain an accurate packet duration estimate.

An input condition for one or more of the look-up tables may consist of a single value determined from the second portion of the data packet, such that the look-up table links the value with a corresponding output. For instance, a look-up table may comprise a plurality of remainders (i.e. the fractional parts between 0 and 1, or the values modulo 1) for a corresponding plurality of possible values from the second portion (e.g. a symbol duration of the data packet such as the value of the T_{SYM} parameter in an IEEE 802.11ax frame). Because some fields in the second portion may only adopt a limited number of values, using a look-up table to determine the remainders of these may be more efficient than providing remainder-calculating processing resources.

Additionally or alternatively, in a set of embodiments, an input condition for one or more of the look-up tables comprises a plurality of values determined from the second portion of the data packet or from the first and second portions of the data packet. Such a look-up table may allow an appropriate output to be determined for many different combinations of possible input values without requiring potentially complex processing steps. For instance, a look-up table may comprise a plurality of remainders for a corresponding plurality of calculations involving several values extracted from the second portion or the first and second portions (e.g. the multiplicative product of the values of N_{HE_LTF} and T_{HE_LTF_SYM} parameters of an IEEE 802.11ax frame).

The radio receiver device may be arranged to perform one or more of the determining steps at the same time as receiving the radio signal comprising the data packet. In other words, the determination of the initial estimate, the correction factor and/or the refined estimate may occur whilst the data packet is still being received. Determining an estimate for the packet duration whilst the packet is still being received may provide the radio receiver device with more time for processing the data packet, e.g. to prepare an appropriate response for transmitting promptly after the end of the data packet.

According to a second aspect of the present invention there is provided a method of operating a radio receiver device comprising:
receiving a radio signal comprising a data packet with a packet duration, said data packet comprising a first portion and a second portion;
determining an initial estimate of the packet duration using data included in the first portion;
determining a correction factor for said initial estimate of the packet duration using data included in the second portion; and
combining the initial estimate and the correction factor to determine a refined estimate for the packet duration.

The radio receiver device may comprise one or more dedicated hardware elements arranged to determine the initial estimate and/or the correction factor and/or the refined estimate (e.g. the radio receiver device may comprise a pipeline architecture for determining the initial estimate and/or the correction factor and/or the refined estimate). Additionally or alternatively, the radio receiver device may comprise a processor arranged to determine the initial estimate and/or the correction factor and/or the refined estimate, e.g. by executing appropriate software.

Accordingly, the present invention extends to computer software that, when executed by a radio receiver device, causes said radio receiver device to perform the method disclosed herein. The radio receiver device may comprise a memory storing said software. The radio receiver device may comprise a processor arranged to execute said software.

The present invention extends to a radio communication system comprising:
a radio transmitter device arranged to transmit a radio signal comprising data packet having a packet duration; and
the radio receiver device as disclosed herein, arranged to receive said radio signal and to determine a refined estimate for the packet duration of said data packet.

As explained above, the radio receiver device may be a radio transceiver device arranged to transmit a radio signal comprising a response to the data packet at a response time determined using the refined estimate of the packet duration. The radio transmitter device may be a radio transceiver device arranged to receive said response.

Being able to accurately estimate a data packet duration may be particularly useful for multiple user communication protocols (e.g. an 802.11ax OFDMA protocol), e.g. where it may be beneficial to accurately synchronise responses from multiple users to a single trigger data packet.

In a set of embodiments, the radio communication system comprises a second radio receiver device arranged to receive said radio signal and to determine a refined estimate for the packet duration of said data packet. The second radio receiver device may comprise any of the features described above with respect to the (first) radio receiver device, although the first and second radio receiver devices may not necessarily be arranged identically. The second radio receiver device may comprise a second radio transceiver device arranged to transmit a radio signal comprising a response to the data packet at a response time determined using its refined estimate of the packet duration. The first and second radio receiver devices may be arranged to synchronise their responses.

Features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the first aspect described above may also apply to the other aspects of the invention.

### BRIEF DESCRIPTION OF THE DRAWINGS

One or more non-limiting examples will now be described, by way of example only, and with reference to the accompanying figures in which:

FIG. 1 is a schematic view of a radio communication system according to an embodiment of the invention; and

FIG. 2 is a timing and flow diagram illustrating operation of the radio communication system.

### DETAILED DESCRIPTION

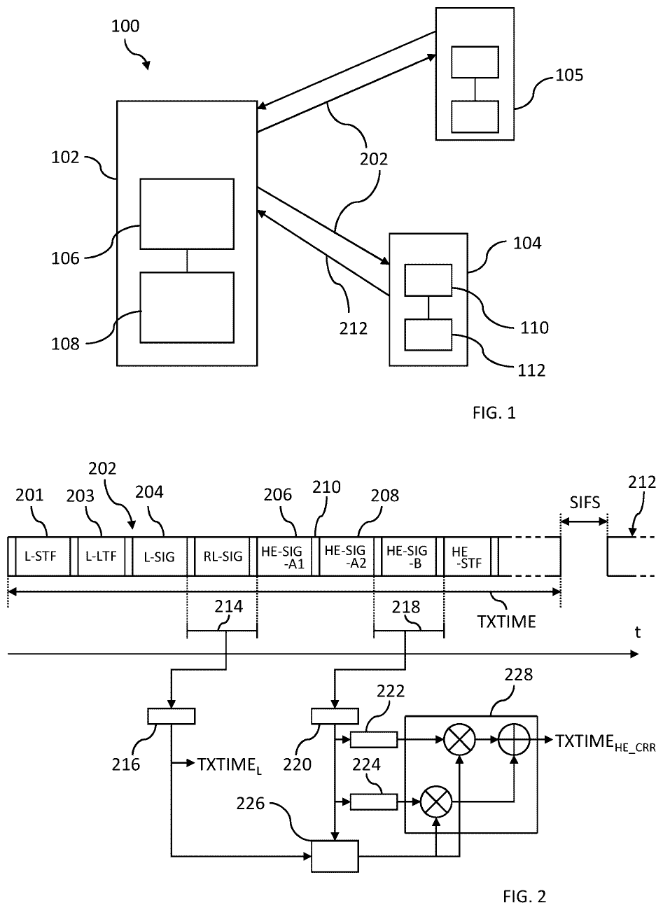

A radio communication system 100, shown in FIG. 1, comprises a first radio transceiver device 102, a second radio transceiver device 104 and a third radio transceiver device 105. In this example, the first radio transceiver device 102 is an IEEE 802.11 access point and the second and third radio transceiver devices 104, 105 are IEEE 802.11 client device stations. The first, second and third radio transceiver devices 102, 104, 105 are arranged to communicate according to the IEEE 802.11ax wireless local area network standard, and specifically using Orthogonal frequency-division multiple access (OFDMA) IEEE High Efficiency Multi-User (HE MU) transmissions.

The first radio transceiver device 102 comprises a memory 106 storing software that is executed by a processor 108 to cause the first radio transceiver device to prepare and transmit data packets to the second and third radio transceiver devices 104, 105 and to receive and process data packets from the second and third radio transceiver devices 104, 105. Similarly, the second radio receiver device 104 comprises a memory 110 storing software that is executed by a processor 112 to cause the second radio transceiver device 104 to receive and process data packets from the first radio transceiver device 102 and to prepare and transmit data packets to the first radio transceiver device 102. The third radio transceiver device 105 is configured in the same way as the second radio transceiver device 104.

Although not shown in FIG. 1, the first, second and third radio transceiver devices 102, 104, 105 also comprise additional radio communication and processing components to facilitate the transmitting and receiving of said data packets. For instance, the processors 108, 112 may handle (amongst other processes) physical layer (PHY) processes such as encoding, decoding, synchronisation and carrier frequency offset estimation and the radio transceiver devices may also comprise RF frontend portions handling processes such as modulation, multiplexing, demultiplexing and sampling (e.g. comprising one or more DACs, ADCs, mixers, filters, amplifiers and/or baluns).

The operation of the radio communication system 100 will now be described with additional reference to FIG. 2. This description will focus primarily on the operation of the second radio transceiver device 104, but the same operations are also performed by the third radio transceiver device 105.

In use, the first radio transceiver device 102 broadcasts a trigger data packet 202, which is received by the second and third radio transceiver devices 104. In this example the trigger data packet 202 uses a High-Efficiency Multiple User (HE-MU) physical layer protocol data unit (PPDU) format (i.e. packet structure) with several portions including an L-STF portion 201, an L-LTF portion 203, an L-SIG portion 204, an HE-SIG-A1 portion 206 and an HE-SIG-A2 portion 208. The portions of the packet 202 are surrounded by guard intervals 210.

The trigger data packet 202 has a duration TXTIME. After a Short Interframe Space (SIFS) has passed from the end of the trigger data packet 202, the second radio transceiver device 104 transmits a response data packet 212 to the first radio transceiver device 102. The third radio transceiver device 105 also transmits a response data packet after the SIFS (not shown). The response data packet 212 may be a simple acknowledgement or it may contain a substantive data payload. The response data packet 212 uses a High-Efficiency Trigger Based (HE-TB) physical layer protocol data unit (PPDU) format. The response data packets from the second and third radio transceiver devices 104, 105 must each be sent accurately at the end of the SIFS (with an accuracy of ±0.4 μs is) to avoid timing mismatches which may make the response data packets difficult or impossible to decode.

To transmit the response data packet 212 accurately at the end of the SIFS, the second radio transceiver device uses information in the L-SIG, HE-SIG-A1 and HE-SIG-A2 portions 204, 206 208 to estimate the duration TXTIME of the trigger data packet 202. This estimation is performed as the rest of the trigger data packet 202 is still being received.

In an initial step, the second radio transceiver device 104 estimates the start time of the trigger packet 202 using the preamble fields L-STF 201 and L-LTF 203 of the packet.

The processor 112 then decodes the L-SIG portion 204 in a first decoding time 214.

Then, in step 216, the processor 112 extracts LENGTH and RATE values from the decoded L-SIG portion 204 and uses these to calculate an initial estimate TXTIME_{L} for the duration of trigger data packet 202 as follows:

$${TXTIME}_{L} = 20 + ⌈ \frac{16 + 8 \cdot LENGTH + 6}{{N}_{D P B S}} ⌉ \times 4 ,$$

where N_{DPBS} is mapped from the RATE field and can take values 6, 9, 12, 18, 24, 36, 48 or 54.

The HE-SIG-A1 and HE-SIG-A2 portions 206, 208 are decoded in a second decoding time 218.

Then, in step 220, the processor 112 extracts T_{SYM}, N_{HE_LTF}, and T_{HE_LTF_SYM}, M_{MA}, and b_{PE-Disambiguity} values from the decoded HE-SIG-A1 and HE-SIG-A2 portions 206, 208.

The T_{SYM} value is used with a first look-up table 222 stored in the memory 110 to determine mod (T_{SYM}, 1). T_{SYM} can take only 3 different values: 13.6, 14.4 or 16, and the first look-up table 222 has three corresponding entries: 0.6, 0.4 or 0.

The N_{HE_LTF}, and T_{HE_LTF_SYM} values are used with a second look-up table 224 to determine mod (N_{HE_LTF}×T_{HE_LTF_SYM}, 1). N_{HE_LTF} can validly take values 1, 2 and 4, and T_{HE_LTF_SYM} can validly be 4, 7.2, 8, 13.6 or 16. The second look-up table 224 has five entries corresponding to the corresponding possible values of mod (N_{HE_LTF}×T_{HE_LTF_SYM}, 1): 0, 0.2, 0.4, 0.6 or 0.8.

In step 226, the processor 112 determines values N_{SYM} and N_{MA} using values extracted from the L-SIG, HE-SIG-A1 and HE-SIG-A2 portions 204, 206, 208 according to:

$${N}_{S Y M} = ⌊ ( \frac{LENGTH + m + 3}{3} \times 4 - {T}_{HE - PREAMBLE} - {N}_{M A} {N}_{HE \_ HTF} {T}_{HE \_ LTF \_ SYM} ) / {T}_{S Y M} ⌋ - {b}_{PE - Disambiguity} ,$$

where:

$${T}_{HE - PREAMBLE} = 4 + 8 {N}_{HE \_ SIG \_ A} + 4 {N}_{HE \_ SIG \_ B} + 4 {N}_{HE \_ LTF} {T}_{HE \_ LTF \_ SYM} ,$$

$${N}_{HE \_ SIG \_ A} = \{ \begin{matrix}1 , for HE - SU , HE - MU and HE - TB \\ 2 , for HE - ER - SU\end{matrix} , and$$

$${N}_{HE \_ SIG \_ B} = \{ \begin{matrix}0 , for HE - SU , HE - ER - SU and HE - TB \\ \geq 1 , for HE - MU\end{matrix} .$$

And,

$${N}_{MA} = ⌊ ( \frac{LENGTH + m + 3}{3} \times 4 - {T}_{HE - PREAMBLE} - ( {b}_{PE - Disambiguity} + 2 ) {T}_{SYM} ) / {T}_{MA} ⌋ , if Doppler = 1 , else 0 ,$$

$$where :$$

$${T}_{MA} = {M}_{MA} {T}_{SYM} + {N}_{HE \_ LTF} {T}_{HE \_ LTF \_ SYM} .$$

Next, in step 228, the determined values of N_{SYM} and N_{MA} and used to determine a correction factor TXTIME_{HE_CORR}.

$${TXTIME}_{HE \_ CORR} = {N}_{SYM} \times mod ( {T}_{SYM} , 1 ) + ( {N}_{MA} + 1 ) \times mod ( {N}_{HE \_ LTF} \times {T}_{HE \_ LTF \_ SYM} , 1 ) .$$

Finally, the correction factor TXTIME_{HE_CORR} is combined with the initial estimate TXTIME to determine a refined estimate for the duration of trigger data packet 202:

$${TXTIME}_{HE} = {TXTIME}_{L} - {TXTIME}_{HE \_ CORR .}$$

Thus, the second radio transceiver device 104 is able to determine an accurate estimate for the duration of the trigger data packet 202 with only modest processing resources. In particular, the use of the look-up tables 222, 224 to determine mod (T_{SYM}, 1) and mod (N_{HE_LTF}×T_{HE_LTF_SYM}, 1) avoids the need for complex circuitry that would otherwise be required to calculate the refined estimate with high accuracy.

The processor 112 then adds the refined estimate TXTIME_{HE} for the duration of trigger data packet 202 and the SIFS to the detected start time to determine the appropriate response time. The second radio transceiver device 104 can then send the response data packet 212 accurately at the end of the SIFS. The third radio transceiver device 105 performs a corresponding process to send its own response data packet. Because the refined estimates for the duration of trigger data packet 202 are accurate, the responses of the second and third radio transceiver devices 104, 105 are well synchronised.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A radio receiver device configured:
to receive a radio signal comprising a data packet with a packet duration, said data packet comprising a first portion and a second portion;
to determine an initial estimate of the packet duration using data included in the first portion;
to determine a correction factor for said initial estimate of the packet duration using data included in the second portion; and
to combine the initial estimate and the correction factor to determine a refined estimate of the packet duration.

2. The radio receiver device of claim 1, arranged to detect a start time of the data packet, and to calculate an end time of the packet by adding the refined estimate of the packet duration to the start time.

3. The radio receiver device of claim 1, wherein the radio receiver device is a radio transceiver device arranged to use the refined estimate of the packet duration to determine a response time for responding to the data packet, and to transmit a radio signal comprising a response to the data packet at a determined response time.

4. The radio receiver device of claim 1, wherein at least part of the data packet is modulated according to an orthogonal frequency-division multiplexing (OFDM) scheme.

5. The radio receiver device of claim 1, wherein the first portion includes information identifying a quantity of data contained in the data packet and information identifying a data rate of the data packet, and determining the initial estimate of the packet duration comprises combining said information.

6. The radio receiver device of claim 1, wherein the data packet is an IEEE 802.11ax data packet.

7. The radio receiver device of claim 6, wherein the first portion comprises a legacy signal (L-SIG) portion of the IEEE 802.11ax data packet.

8. The radio receiver device of claim 1, arranged to determine one or more values from the second portion and to perform one or more mathematical operations to said value(s) to determine the correction factor.

9. The radio receiver device of claim 1, wherein the second portion includes information identifying one or more of: a symbol duration in the data packet, a number of symbols in one or more fields of the data packet, a duration of one or more fields in the data packet, a midamble periodicity of the data packet, and packet extension information.

10. The radio receiver device of claim 1, wherein the second portion comprises a High-Efficiency Signal (HE-SIG) portion of an IEEE 802.11ax data packet.

11. The radio receiver device of claim 1, wherein determining the correction factor comprises using one or more look-up tables which associate a plurality of input conditions with a corresponding plurality of outcomes.

12. The radio receiver device of claim 11, arranged to use a look-up table comprising a plurality of remainders for a corresponding plurality of possible values from the second portion.

13. The radio receiver device of claim 11, arranged to use a look-up table comprising a plurality of remainders for a corresponding plurality of calculations involving several values extracted from the second portion or the first and second portions.

14. The radio receiver device radio of claim 1, arranged to perform one or more of the determining steps at the same time as receiving the radio signal comprising the data packet.

15. The radio receiver device radio of claim 1, comprising a pipeline architecture for determining the initial estimate and/or the correction factor and/or the refined estimate.

16. (canceled)

17. A method of operating a radio receiver device comprising:
receiving a radio signal comprising a data packet with a packet duration, said data packet comprising a first portion and a second portion;
determining an initial estimate of the packet duration using data included in the first portion;
determining a correction factor for said initial estimate of the packet duration using data included in the second portion; and
combining the initial estimate and the correction factor to determine a refined estimate for the packet duration.

18. (canceled)

19. A radio communication system comprising:
a radio transmitter device arranged to transmit a radio signal comprising a data packet having a packet duration, said data packet comprising a first portion and a second portion; and
a radio receiver device configured:
to receive said radio signal;
to determine an initial estimate of the packet duration using data included in the first portion;
to determine a correction factor for said initial estimate of the packet duration using data included in the second portion; and
to combine the initial estimate and the correction factor to determine a refined estimate of the packet duration.

20. The radio communication system of claim 19, wherein the radio receiver device is a first radio transceiver device arranged to transmit a response radio signal comprising a response to the data packet at a response time determined using the refined estimate of the packet duration.

21. The radio communication system of claim 20, comprising a second radio transceiver device arranged:
to receive said radio signal and to determine a refined estimate for the packet duration of said data packet; and
to transmit a response radio signal comprising a response to the data packet at a response time determined using the refined estimate of the packet duration.

22. The radio communication system of claim 21, wherein the first and second radio transceiver devices are arranged to synchronise their response radio signals.
